(19) United States
(12) Patent Application Publication
(10) Pub. No.: US 2025/0156042 A1
(43) Pub. Date: May 15, 2025

(54) METHOD AND APPARATUS, ELECTRONIC DEVICE, AND STORAGE MEDIUM FOR OBJECT INTERACTION

(71) Applicant: Beijing Youzhuju Network Technology Co., Ltd., Beijing (CN)

(72) Inventors: Weijia Kong, Beijing (CN); Haoran Li, Beijing (CN); Jinhui Guo, Beijing (CN); Shengyan Shi, Beijing (CN); Hao Yang, Beijing (CN); Jingtong Jian, Beijing (CN); Lang Deng, Beijing (CN); Shaoying Liu, Beijing (CN); Tingpeng Tu, Beijing (CN); Yunpeng Liang, Beijing (CN)

(21) Appl. No.: 18/941,250

(22) Filed: Nov. 8, 2024

(30) Foreign Application Priority Data
Nov. 9, 2023 (CN) 202311491938.3

(51) Int. Cl. G06F 3/0484; G06F 3/0487

(52) U.S. Cl. CPC G06F 3/0484; G06F 3/0487

(57) ABSTRACT

Embodiments of the present disclosure provide a method and apparatus, an electronic device, and a storage medium for object interaction. The method includes: displaying a preset object container in a media content display page, where at least two interaction objects are contained in the preset object container, and the at least two interaction objects are movable upon receipt of a first trigger operation; and when a first display condition is satisfied, displaying resource object information corresponding to a target interaction object in the at least two interaction objects, where the resource object information is object information of a resource object, and the resource object is associated with target media content currently displayed in the media content display page.

### CROSS-REFERENCE TO RELATED APPLICATION(S)

This application claims priority to Chinese Application No. 202311491938.3 filed Nov. 9, 2023, the disclosure of which is incorporated herein by reference in its entirety.

### FIELD

Embodiments of the present disclosure relate to the field of computer technologies, and in particular, to a method and apparatus, an electronic device, and a storage medium for object interaction.

### BACKGROUND

Currently, a user can watch a video in a video playback page, and when an interactive window is displayed in the video playback page, the user can interact with an interactive object displayed in the interactive window by clicking.

### SUMMARY

Embodiments of the present disclosure provide a method and apparatus, an electronic device, and a storage medium for object interaction, to enrich a display manner and an interaction manner of an interactive object.

In a first aspect, an embodiment of the present disclosure provides a method for object interaction, comprising:
displaying a preset object container in a media content display page, wherein at least two interaction objects are contained in the preset object container, and the at least two interaction objects move upon receipt of a first trigger operation; and
displaying, in response to a first display condition being satisfied, resource object information corresponding to a target interaction object of the at least two interaction objects, wherein the resource object information is object information of a resource object, and the resource object is associated with target media content being displayed in the media content display page.

In a second aspect, an embodiment of the present disclosure further provides an apparatus for object interaction, comprising:
a container display module, configured to display a preset object container in a media content display page, wherein at least two interaction objects are contained in the preset object container, and the at least two interaction objects move upon receipt of a first trigger operation; and
an information display module, configured to display, in response to a first display condition being satisfied, resource object information corresponding to a target interaction object of the at least two interaction objects, wherein the resource object information is object information of a resource object, and the resource object is associated with target media content being displayed in the media content display page.

In a third aspect, an embodiment of the present disclosure further provides an electronic device, comprising:
one or more processors;
a memory, configured to store one or more programs,
wherein when the one or more programs are executed by the one or more processors, the one or more processors are caused to implement the object interaction method according to the embodiment of the present disclosure.

In a fourth aspect, an embodiment of the present disclosure further provides a computer-readable storage medium, having a computer program stored thereon, where the program, when executed by a processor, causes the processor to perform the method for object interaction according to the embodiment of the present disclosure.

According to the object interaction method and apparatus, the electronic device, and the storage medium provided in the embodiments of the present disclosure, the preset object container is displayed in the media content display page, the preset object container contains at least two interaction objects, and the at least two interaction objects move upon receipt of the first trigger operation; in response to the first display condition being satisfied, the resource object information corresponding to the target interaction object of the at least two interaction objects is displayed, the resource object information is the object information of the resource object, and the resource object is associated with the target media content being displayed in the media content display page. With the above technical solution, the embodiments of the present disclosure can display the interaction objects in the manner of the object container, and enable the user to view the resource object information corresponding to the interaction objects when the first display condition is satisfied, thereby enriching the display manner of the interaction objects and the interaction manner based on the displayed interaction objects.

### BRIEF DESCRIPTION OF THE DRAWINGS

The above and other features, advantages, and aspects of the embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of an object interaction method according to an embodiment of the present disclosure;

FIG. 2 is a schematic diagram of displaying a preset object container according to an embodiment of the present disclosure;

FIG. 3 is a schematic diagram of displaying a first interaction control according to an embodiment of the present disclosure;

FIG. 4 is a schematic diagram of displaying another preset object container according to an embodiment of the present disclosure;

FIG. 5 is a schematic diagram of displaying an interaction object according to an embodiment of the present disclosure;

FIG. 6 is a schematic diagram of displaying resource object information according to an embodiment of the present disclosure;

FIG. 7 is a schematic diagram of displaying a second interaction control according to an embodiment of the present disclosure;

FIG. 8 is a schematic flowchart of another object interaction method according to an embodiment of the present disclosure;

FIG. 9 is a schematic diagram of a display process of resource object information according to an embodiment of the present disclosure;

FIG. 10 is a schematic diagram of another display process of resource object information according to an embodiment of the present disclosure;

FIG. 11 is a schematic diagram of a further display process of resource object information according to an embodiment of the present disclosure;

FIG. 12 is a block diagram of a structure of an apparatus for object interaction according to an embodiment of the present disclosure; and

FIG. 13 is a schematic diagram of a structure of an electronic device according to an embodiment of the present disclosure.

### DETAILED DESCRIPTION OF EMBODIMENTS

Embodiments of the present disclosure are described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that modifiers such as “one” and “a plurality of” mentioned in the present disclosure are illustrative and not restrictive, and those skilled in the art should understand that unless the context clearly indicates otherwise, it should be understood as “one or more”.

The names of messages or information exchanged between a plurality of apparatuses in the implementations of the present disclosure are used for illustrative purposes only, and are not used to limit the scope of these messages or information.

It may be understood that before using the technical solutions disclosed in the embodiments of the present disclosure, the types, scope of use, and scenarios of use of personal information involved in the present disclosure shall be informed to the user and the user's authorization shall be obtained by an appropriate manner in accordance with relevant laws and regulations.

For example, prompt information is sent to the user in response to receipt of an active request from the user, so as to explicitly prompt the user that the operation requested by the user will need to obtain and use the user's personal information. Therefore, the user can independently choose whether to provide personal information to software or hardware such as an electronic device, an application, a server, or a storage medium that executes the operation of the technical solution of the present disclosure according to the prompt information.

As an optional but non-limiting implementation manner, for example, a manner of sending prompt information to the user in response to receipt of an active request from the user may be in a pop-up window, and the prompt information may be presented in text in the pop-up window. In addition, the pop-up window may also carry a selection control for the user to choose to “agree” or “disagree” to provide personal information to the electronic device.

It may be understood that the above notification and user authorization process are only illustrative and do not limit the implementation of the present disclosure. Other manners that meet relevant laws and regulations may also be applied to the implementation of the present disclosure.

In the prior art, the display manner and the interaction manner of the interactive object are single.

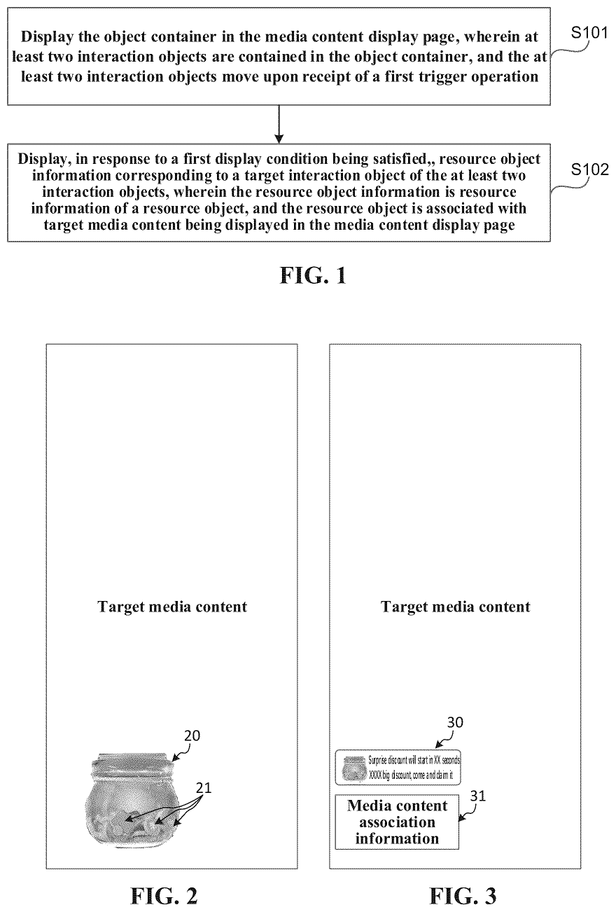

FIG. 1 is a schematic flowchart of an object interaction method according to an embodiment of the present disclosure. The method may be performed by an apparatus for object interaction, and the apparatus may be implemented by software and/or hardware, and may be configured in an electronic device, and typically, may be configured in a mobile phone or a tablet computer. The object interaction method provided in this embodiment of the present disclosure is applicable to a scenario of displaying an interaction object in an object container and displaying a resource object associated with media content when a set condition is satisfied. As shown in FIG. 1, the object interaction method provided in this embodiment may include:

S101: Display a preset object container in a media content display page, and at least two interaction objects are contained in the preset object container, and the at least two interaction objects move upon receipt of a first trigger operation.

The media content display page may be a page for displaying media content, such as a video playback page. The displayed media content may include, for example, a video and/or a graphic. The preset object container may be a preset container for containing the interaction object. For example, the preset object container may be a three-dimensional container. The display style of the preset object container is not limited. For example, the preset object container may be a can style, a sphere style, or a box style. At least two interaction objects are contained in the preset object container. The interaction object may have a corresponding resource object for the user to obtain. The interaction object may be displayed as a coin type, a red envelope type, or a ball type, and may be specifically set as required.

The interaction object displayed in the preset object container may support responding to a first trigger operation from the user, such as moving in the media content display page with the first trigger operation of the user. The first trigger operation may be a trigger operation for instructing the displayed interaction object to move in the preset object container or a second preset region. The execution manner of the first trigger operation is not limited. Alternatively, the first trigger operation comprises a shake trigger operation and/or a trigger operation for a preset button, and the preset button is configured on the preset object container. The shake trigger operation may be a trigger operation of shaking an electronic device on which the media content display page is displayed. A shaking amplitude of the shake trigger operation may be greater than or equal to a preset angle threshold, and a number of consecutive shakes of the shake trigger operation may be greater than or equal to a preset number threshold, and a time interval between two adjacent shakes may be less than or equal to a set time interval threshold. The preset button may be a button configured on the preset object container, and may be configured to trigger and control the interaction object in the preset object container to move in the preset object container.

For example, as shown in FIG. 2, when target media content with an associated resource object is displayed in the media content display page, the preset object container 20 may be displayed in the media content display page, and at least two interaction objects 21 may be displayed in the preset object container 20, so that the user may interact based on the preset object container 20.

In this embodiment, the preset object container may contain one or more types of interaction objects. Alternatively, the at least two interaction objects are at least two types of interaction objects. For example, the preset object container may contain both a coin type of interaction object and a red envelope type of interaction object, as shown in FIG. 2, to further enrich the display style of the interaction objects.

In this embodiment, the display timing of the preset object container may be set as required. For example, the preset object container may be displayed in the media content display page when the target media content with an associated resource object starts to be displayed. Alternatively, the preset object container may not be displayed in the media content display page when the target media content starts to be displayed, but the preset object container is displayed in the media content display page after a certain condition is met.

In some implementations, displaying a preset object container in a media content display page comprises: displaying a first interaction control associated with the preset object container in the media content display page; and when a third display condition is satisfied, canceling displaying of the first interaction control, and displaying the preset object container at an associated position of the first interaction control, wherein the third display condition comprises: receiving a fourth trigger operation for the first interaction control, and/or a display duration of the first interaction control reaching a fifth preset duration.

The first interaction control may be a control for triggering display of the preset object container, and content displayed in the first interaction control is not limited. For example, an image of the preset object container, prompt information for prompting the user to obtain the resource object, and/or a countdown for displaying the preset object container may be displayed in the first interaction control, and the countdown may be understood as a remaining duration until the preset object container is displayed, that is, the preset object container may be displayed in the media content display page after the countdown ends. The third display condition may be a display condition of the preset object container, and the third display condition may comprise receiving the fourth trigger operation for the first interaction control and/or the display duration of the first interaction control reaching the fifth preset duration. The fourth trigger operation may be an operation of triggering the first interaction control. For example, the fifth preset duration may be set to 3 s or 5 s, and this embodiment is not limited thereto. The associated position of the first interaction control may be understood as a position associated with the first interaction control, such as a position within a preset distance range from the first interaction control. For example, when the image of the preset object container is displayed in the first interaction control, the associated position of the first interaction control may be a display position of the image of the preset object container in the first interaction control.

In the above implementations, the preset object container may be displayed in the media content display page when the third display condition is satisfied.

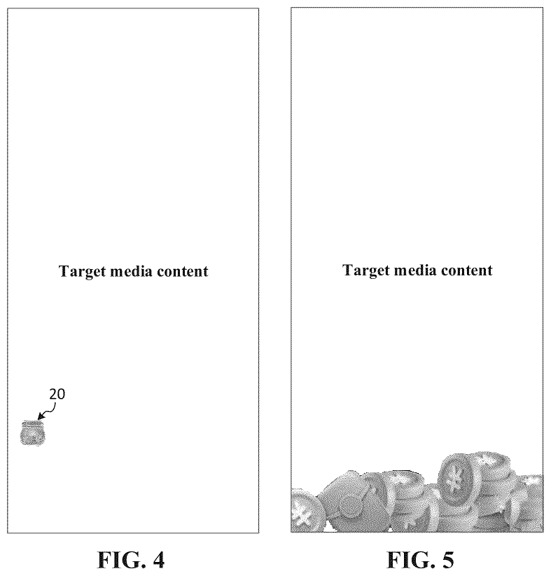

For example, when the target media content with an associated resource object is displayed in the media content display page, the first interaction control 30 may be displayed in the media content display page, and information such as the image of the preset object container, the prompt information for prompting the user to obtain the resource object, and/or the countdown for displaying the preset object container may be displayed in the first interaction control 30, as shown in FIG. 3. Therefore, when it is detected that the user triggers the first interaction control 30 or when the display duration of the first interaction control 30 reaches the fifth preset duration (that is, the countdown ends), the first interaction control 30 may be canceled from being displayed, and the preset object container 20 may be displayed at the associated position of the first interaction control 30, as shown in FIG. 4.

In the above implementations, as shown in FIG. 3, when the preset object container 20 and/or the interaction object 21 are not displayed in the media content display page, media content association information of the target media content may be displayed in an information region 31 of the media content display page. Therefore, when the third display condition is satisfied, the media content association information may continue to be displayed, for example, only the first interaction control 30 is canceled from being displayed; or the media content association information may be canceled from being displayed, that is, both the first interaction control 30 and the media content association information are canceled from being displayed, as shown in FIG. 4. In this case, alternatively, the media content association information of the target media content is further displayed in the media content display page, and the object interaction method provided in this embodiment further comprises: when the third display condition is satisfied, canceling displaying of the media content association information. The media content association information may be understood as information associated with the target media content, for example, description information, publisher information, and/or a details control associated with the target media content. The description information may include, for example, a title, a brief introduction, and/or an abstract. The publisher information may include, for example, a nickname and/or an avatar of the publisher. The details control may be used to trigger viewing of details information of a recommended object of the target media content. The recommended object of the target media content may be understood as an object recommended by the target media content, for example, a recommended place or item.

In the above implementations, after the preset object container is displayed at the associated position of the first interaction control, the displayed preset object container may be further controlled to move and/or adjust a display size or a display style of the preset object container. Exemplarily, the preset object container may be controlled to move from the associated position of the first interaction control (as shown in FIG. 4) to a third preset region of the media content display page along a set moving route, and after the first interaction control moves to the third preset region of the media content display page, the preset object container may be displayed in the third preset region (as shown in FIG. 2). In this case, alternatively, after the preset object container is displayed at the associated position of the first interaction control, the method further comprises controlling the preset object container to move to the third preset region of the media content display page. The third preset region may be understood as a display region after the preset object container moves, for example, a lower left corner, a lower right corner, or a region at a bottom of the media content display page.

In the above implementations, when the preset object container is controlled to move from the associated position of the first interaction control to the third preset region of the media content display page, a size of the preset object container may be controlled to remain unchanged; or the display size of the preset object container may be adjusted, for example, the display size of the preset object container is increased, which may be specifically set as required.

In some implementations, after the preset object container is displayed, the interaction objects may be continuously displayed in the preset object container until a current condition satisfies the first display condition.

In some other implementations, when a display duration of the preset object container reaches a fourth preset duration, the interaction objects may no longer be displayed in the preset object container, but the interaction objects are moved to a certain region of the media content display page for display, for example, the region is used as a new container, and the interaction objects are displayed in the new container. In this case, alternatively, after the preset object container is displayed in the media content display page, the method further comprises: when the display duration of the preset object container reaches the fourth preset duration, canceling displaying of the preset object container, and displaying the at least two interaction objects in a second preset region of the media content display page, and the at least two interaction objects are displayed at a bottom of the second preset region.

The fourth preset duration may be a duration for canceling displaying of the preset object container, which may be set as required. For example, the fourth preset duration may be set to 1 s or 3 s. The second preset region may be a region in the media content display page for displaying the at least two interaction objects, for example, a certain region in the media content display page. Alternatively, the second preset region is a picture display region of the media content display page, and the picture display region is configured to display a media content picture, so as to present a visual effect of using the picture display region of the media content display page as a new container and containing the at least two interaction objects in the new container. The picture display region may be a region in the media content display page for displaying the media content picture.

Exemplarily, when the display duration of the preset object container reaches the fourth preset duration, the preset object container may be canceled from being displayed, and the interaction objects contained in the preset object container may continue to be displayed in the second preset region of the media content display page, as shown in FIG. 5. For example, the preset object container may be controlled to be enlarged and fade away, and the interaction objects in the preset object container may be controlled to be scattered at the bottom of the second preset region to facilitate subsequent interaction using the second preset region as a new container of the interaction objects.

S102: In response to a first display condition being satisfied, display resource object information corresponding to a target interaction object of the at least two interaction objects, and the resource object information is object information of a resource object, and the resource object is associated with target media content being displayed in the media content display page.

The first display condition may be a condition for displaying resource object information corresponding to a certain interaction object. The first display condition may be flexibly set as required. Alternatively, the first display condition comprises at least one of the following: receipt of the first trigger operation, receipt of a second trigger operation for the preset object container, or a display duration of the at least two interaction objects reaching a first preset duration. Therefore, when the first trigger operation is received, when the second trigger operation for the preset object container is received, and/or when the display duration of the at least two preset objects reaches the first preset duration, it may be determined that the current condition satisfies the first display condition. The first trigger operation and the second trigger operation may be different trigger operations. For example, the first trigger operation may include a shake trigger operation and/or a trigger operation for a preset button configured on the preset object container, and the second trigger operation may be an operation of triggering a position other than the preset button of the preset object container. The first preset duration may be set as required. For example, the first preset duration may be set to 3 s, 4 s, or 5 s.

The target interaction object may be an interaction object corresponding to the displayed resource object information. The target interaction object may be randomly determined or determined based on a trigger operation from the user. For example, when the first display condition is satisfied, an interaction object randomly selected from the displayed at least two interaction objects may be used as the target interaction object; or an interaction object triggered by the user is used as the target interaction object. Alternatively, the at least two interaction objects are at least two types of interaction objects, an object type of the target interaction object is a target type in the at least two types. For example, when there are at least two types of interaction objects, a certain interaction object of the target type may be used as the target interaction object. The target type may be preset, for example, the target type may be a red envelope type.

The resource object information may be understood as object information of the resource object. The resource object may be an object that can be obtained by the user. The type of the resource object is not limited. For example, the resource object may be a virtual object or a non-virtual object. The resource object may be associated with the currently displayed target media content. For example, the resource object may be used by the user when obtaining an item recommended by the target media content, or may be used by the user in a place where the item recommended by the target media content belongs or a place recommended by the target media content.

Alternatively, the resource object is configured to perform resource interaction, and the resource object information comprises expiry information of the resource object. For example, the resource object may be a coupon, and the user may use the coupon when performing resource transfer. The resource object information may include the expiry information of the resource object, so that the user can know the expiry of the resource object. In addition, the object of the resource object may further include preferential information and use condition information of the resource object.

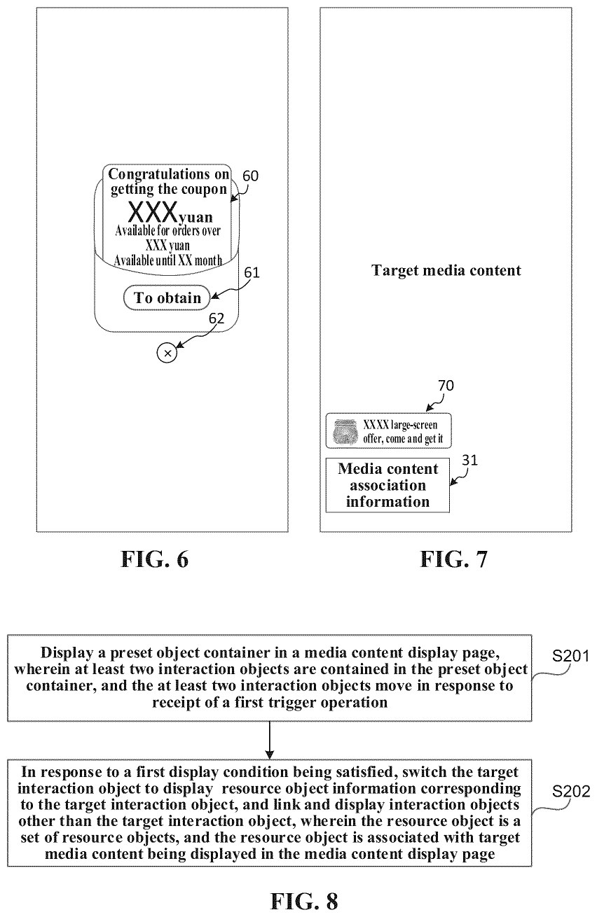

Specifically, when the current condition satisfies the first display condition, the resource object information 60 corresponding to the target interaction object may be displayed in the media content display page, as shown in FIG. 6.

For example, when the first trigger operation from the user is received, when the second trigger operation for the preset object container is received, and/or when the display duration of the at least two interaction objects in the media content display page reaches the first preset duration, the preset object container and/or the interaction objects other than the target interaction object may be controlled to fade away, and the target interaction object is switched to display the resource object information corresponding thereto, for example, an opening animation of the target interaction object is displayed, and the resource object information corresponding to the target interaction object is displayed after the opening animation is played, so as to present a visual effect of the target interaction object being opened and displaying object information of a resource object located inside the target interaction object.

In this embodiment, the first display condition may comprise receiving the first trigger operation from the user. Therefore, when the first trigger operation from the user is received, the at least two displayed interaction objects may be controlled to move in a container (such as the preset object container or the second preset region) where the interaction objects are currently located based on the first trigger operation, and after the first trigger operation is executed, for example, when the number of shakes of the shake trigger operation reaches a preset number threshold, or when a duration since triggering the preset button reaches a preset duration threshold, the resource object information corresponding to the target interaction object may be displayed in the media content display page. In this case, alternatively, the first display condition comprises receiving the first trigger operation, and before displaying resource object information corresponding to the target interaction object of the at least two interaction objects, the method further comprises: controlling, based on the first trigger operation, the at least two interaction objects to move in the preset object container or a second preset region of the media content display page.

It may be understood that for a case where the interaction objects are displayed in the preset object container, when the shake trigger operation is received, the preset object container may be further controlled to shake based on the shake trigger operation.

In some implementations, the method further comprises, after the displaying resource object information corresponding to the target interaction object of the at least two interaction objects: in response to an obtain operation for the resource object, displaying an obtain page of the resource object.

The obtain operation may be a trigger operation for instructing to display the obtain page of the resource object, and an execution manner of the obtain operation is not limited. For example, the obtain operation may be an operation of triggering an obtain control of the resource object. The obtain page may be a page for the user to obtain the resource object, and the user may obtain the resource object on the obtain page. The obtain page and the media content display page may be pages in a same application or different applications.

Specifically, when the obtain operation for the resource object is received, for example, when it is detected that the user triggers an obtain control 61 corresponding to the resource object information 60 (as shown in FIG. 6), the current page may be switched from the media content display page to the obtain page of the resource object, so that the user may obtain the resource object on the obtain page.

It may be understood that in some implementations, the user may also obtain the resource object in the media content display page, for example, when the obtain operation is received, the resource object is triggered to be issued to an account of the user, and information of an object owned by the user in the account is updated; or the resource object is directly triggered to be issued to the account of the user after the resource object information is displayed, and the information of the object owned by the user in the account is updated, without the user performing the obtain operation. In this case, there is no need to switch to the obtain page of the resource object.

In some implementations, the method further comprises, after the displaying resource object information corresponding to the target interaction object of the at least two interaction objects: in response to a cancel display operation for the resource object information, canceling displaying of the resource object information, and displaying a second interaction control in the media content display page, and the second interaction control is configured to trigger redisplaying of the resource object information.

The cancel display operation may be a trigger operation for instructing to cancel display of the resource object information, for example, an operation of triggering a cancel display control corresponding to the resource object information. The second interaction control may be a control configured to trigger redisplaying of the resource object information in the media content display page, and the second interaction control and the first interaction control may have the same or different display styles.

In the above implementations, if the resource object information has been displayed but the user has not obtained the resource object, the second interaction control may be displayed in the media content display page during the process of displaying the target media content, so that the user may quickly re-view the resource object information by triggering the second interaction control, without the need to perform the process of interacting based on the preset object container and/or the interaction objects again.

For example, when the cancel display operation for the resource object information 60 is received, for example, when it is detected that the user triggers a cancel display control 62 corresponding to the resource object information 60 (as shown in FIG. 6), the resource object information 60 may be canceled from being displayed, and the second interaction control 70 may be displayed in the media content display page, as shown in FIG. 7. Therefore, when it is detected that the user triggers the second interaction control 70, the resource object information 60 may be redisplayed in the media content display page, as shown in FIG. 6.

In addition, as shown in FIG. 6, when the cancel display operation for the resource object information 60 is received, the media content association information of the target media content may also be redisplayed in the information region 31 of the media content display page in response to the cancel display operation.

According to the method for object interaction provided in this embodiment of the present disclosure, the preset object container is displayed in the media content display page, the preset object container contains at least two interaction objects, and the at least two interaction objects move upon receipt of the first trigger operation; in response to the first display condition being satisfied, the resource object information corresponding to the target interaction object of the at least two interaction objects is displayed, the resource object information is the object information of the resource object, and the resource object is associated with the target media content being displayed in the media content display page. With the above technical solution, the embodiments of the present disclosure can display the interaction objects in the manner of the object container, and enable the user to view the resource object information corresponding to the interaction objects when the first display condition is satisfied, thereby enriching the display manner of the interaction objects and the interaction manner based on the displayed interaction objects.

FIG. 8 is a schematic flowchart of another method for object interaction according to an embodiment of the present disclosure. The solution in this embodiment may be combined with one or more optional solutions in the above embodiments. Alternatively, the displaying resource object information corresponding to a target interaction object in at least two interaction objects comprises: switching the target interaction object to display the resource object information corresponding to the target interaction object, and canceling the display of interaction objects other than the target interaction object.

Accordingly, as shown in FIG. 8, the object interaction method provided in this embodiment may include:

S201: Display a preset object container in a media content display page, and at least two interaction objects are contained in the preset object container, and the at least two interaction objects move upon receipt of a first trigger operation.

S202: In response to a first display condition being satisfied, switch the target interaction object to display resource object information corresponding to the target interaction object, and cancel the display of interaction objects other than the target interaction object, and the resource object information is object information of a resource object, and the resource object is associated with target media content being displayed in the media content display page.

Specifically, when the first display condition is satisfied, the target interaction object may be switched to display the resource object information corresponding to the target interaction object, and the interaction objects other than the target interaction object are canceled from being displayed to further enrich the display manner of the resource object.

The execution sequence of switching the target interaction object to display the resource object information corresponding to the target interaction object and canceling displaying of the interaction objects other than the target interaction object is not limited. For example, the target interaction object may be switched to display the resource object information corresponding to the target interaction object during, before, or after canceling displaying of the interaction objects other than the target interaction object, which may be specifically set as required.

In some implementations, switching the target interaction object to display resource object information corresponding to the target interaction object, and canceling the display of interaction objects other than the target interaction object comprises: controlling the preset object container to open, and controlling the target interaction object to open to the resource object information corresponding to the target interaction object; and controlling the removal of resource object information from the preset object container, and controlling, during the removal of resource object information, the preset object container and the interaction objects other than the target interaction object to fade away.

In the above implementations, for a case where the target interaction object is displayed in the preset object container when the first display condition is satisfied, the preset object container may be controlled to open, and the target interaction object may be controlled to open to the resource object information corresponding to the target interaction object, so as to present a visual effect of the target interaction object being opened and displaying object information of a resource object located inside the target interaction object. After the preset object container is opened, the target interaction object may be controlled to be removed from the preset object container. During the removal of the target interaction object, the preset object container and the interaction objects other than the target interaction object may be controlled to fade away, and a display size of the target interaction object may be further gradually increased during the moving process of the target interaction object.

In some other implementations, switching the target interaction object to display resource object information corresponding to the target interaction object, and canceling the display of interaction objects other than the target interaction object comprises: controlling the preset object container to fade away, and displaying at least some of the interaction objects in the preset object container in a first preset region of the media content display page; when a second display condition is satisfied, controlling the target interaction object to move in a first direction, and controlling the interaction objects other than the target interaction object to be removed from the media content display page in a second direction, and the second display condition comprises at least one of the following: a duration since receipt of the first trigger operation reaching a second preset duration, receipt of a third trigger operation for the target interaction object, and a display duration of the at least some of the interaction objects in the first preset region reaching a third preset duration; and when the target interaction object moves to a preset position of the media content display page, controlling the target interaction object to open to the resource object information corresponding to the target interaction object.

The second display condition may be a condition for controlling the target interaction object to move to the preset position and controlling the interaction objects other than the target interaction object to be removed from the media content display page. The second display condition may be set as required. For example, the second display condition may comprise that the duration since receipt of the first trigger operation reaches the second preset duration, the third trigger operation for the target interaction object is received, and/or the display duration of the at least some of the interaction objects in the first preset region reaches the third preset duration. The second preset duration, the third preset duration, the first preset region, and the preset position may all be set as required, and this embodiment is not limited thereto. The third trigger operation may be an operation of triggering a displayed interaction object. The first direction and the second direction may be the same or different directions. For example, the first direction and the second direction may be different directions, for example, the first direction may be upward, and the second direction may be downward.

In the above implementations, for a case where the target interaction object is displayed in the preset object container when the first display condition is satisfied, the preset object container may also be controlled to fade away, and at least some of the interaction objects in the preset object container may continue to be displayed in the first preset region (such as a bottom region) of the media content display page.

When the current condition satisfies the second display condition, for example, when the duration since receipt of the first trigger operation reaches the second preset duration, when the third trigger operation for a displayed interaction object (that is, the target interaction object) is received, and/or when the display duration of the at least some of the interaction objects in the first preset region reaches the third preset duration, an interaction object may be randomly selected as the target interaction object or an interaction object triggered by the user is used as the target interaction object, and the target interaction object is controlled to move along the first direction, and the interaction objects other than the target interaction object are controlled to be removed from the media content display page in the second direction.

When the target interaction object moves to the preset position of the media content display page in the first direction, the target interaction object may be controlled to stop moving, and the target interaction object is controlled to open to the resource object information corresponding to the target interaction object.

In some further implementations, switching the target interaction object to displaying resource object information corresponding to the target interaction object, and canceling the display of interaction objects other than the target interaction object comprises: canceling displaying of the interaction objects other than the target interaction object, and controlling the target interaction object to move to a preset position of the media content display page; and when the target interaction object moves to the preset position, controlling the target interaction object to open to the resource object information corresponding to the target interaction object.

In the above implementations, for a case where the target interaction object is not displayed in the preset object container when the first display condition is satisfied, for example, for a case where the target interaction object is displayed in the second preset region of the media content display page when the first display condition is satisfied, the interaction objects other than the target object may be canceled from being displayed, and the target interaction object may be controlled to move to the preset position of the media content display page; and when the target interaction object moves to the preset position of the media content display page, the target interaction object may be controlled to open to the resource object information corresponding to the target interaction object.

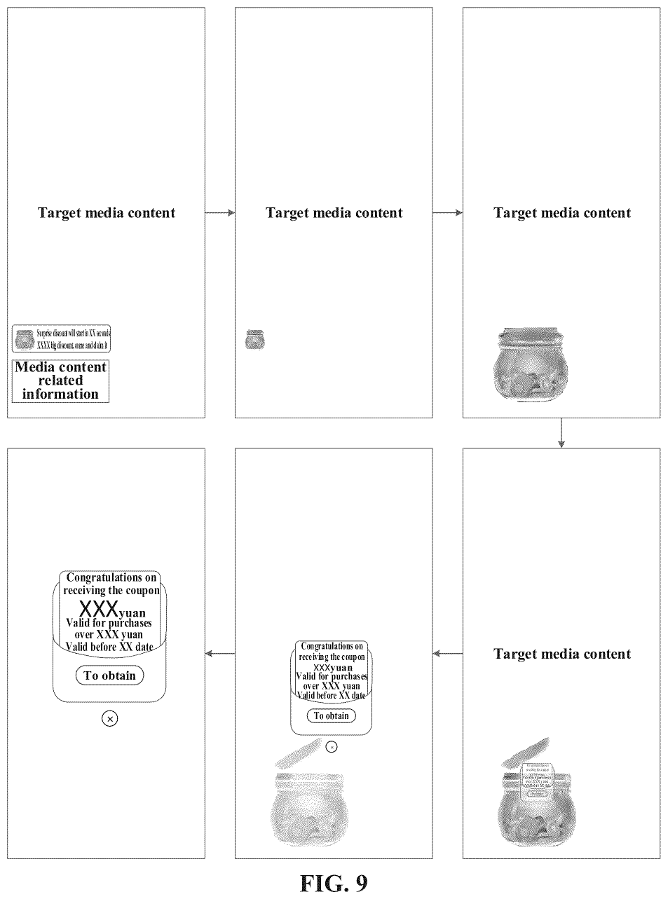

FIG. 9 is a schematic diagram of a display process of resource object information according to an embodiment of the present disclosure. As shown in FIG. 9, in an alternative implementation, the display process of the resource object information may be described as follows.

When the target media content is displayed in the media content display page, the first interaction control may be displayed in the media content display page, and information such as the image of the preset object container, the prompt information for prompting the user to obtain the resource object, and/or the countdown for displaying the preset object container may be displayed in the first interaction control, as shown in the first image of FIG. 9.

When the current condition satisfies the third display condition, for example, when a trigger operation for the first interaction control is received, and/or when the countdown ends (that is, the display duration of the first interaction control reaches the fifth preset duration), the first interaction control may be canceled from being displayed, and the preset object container may be displayed at the associated position of the first interaction control, as shown in the second image of FIG. 9.

After the preset object container is displayed at the associated position of the first interaction control, the preset object container may be further controlled to move to a lower left corner of the media content display page (that is, the third preset region), and a size of the preset object container may be increased during the moving process, as shown in the third image of FIG. 9. After the preset object container moves to the lower left corner of the media content display page, the preset object container may be controlled to stop moving, and the preset object container may be controlled to shake circularly and display shake prompt information (not shown in FIG. 9), and the user is prompted by the shake prompt information that interaction may be performed by executing the shake trigger operation.

When the current condition satisfies the first display condition, for example, when the first trigger operation from the user is received, when the second trigger operation for the preset object container is received, and/or when the display duration of the preset object container (that is, the display duration of the at least two interaction objects contained in the preset object container) reaches the first preset duration, the preset object container is controlled to open, and the target interaction object is controlled to open to the resource object information corresponding to the target interaction object; after the preset object container is opened, the resource object information is controlled to be removed from the preset object container, and during the removal of resource object information, the preset object container and the interaction objects other than the target interaction object may be controlled to fade away, and a display size of the target interaction object may be gradually increased, as shown in the fourth image and the fifth image of FIG. 9. Taking the resource object as a coupon as an example, the preset object container and the interaction objects contained in the preset object container may be controlled to shake, the preset object container disappears after shaking for a period of time (for example, 3 s), and the coupon pops up.

When the resource object information moves to the preset position of the media content display page, the resource object information is controlled to stop moving, and the resource object information is displayed at the preset position, as shown in the sixth image of FIG. 9.

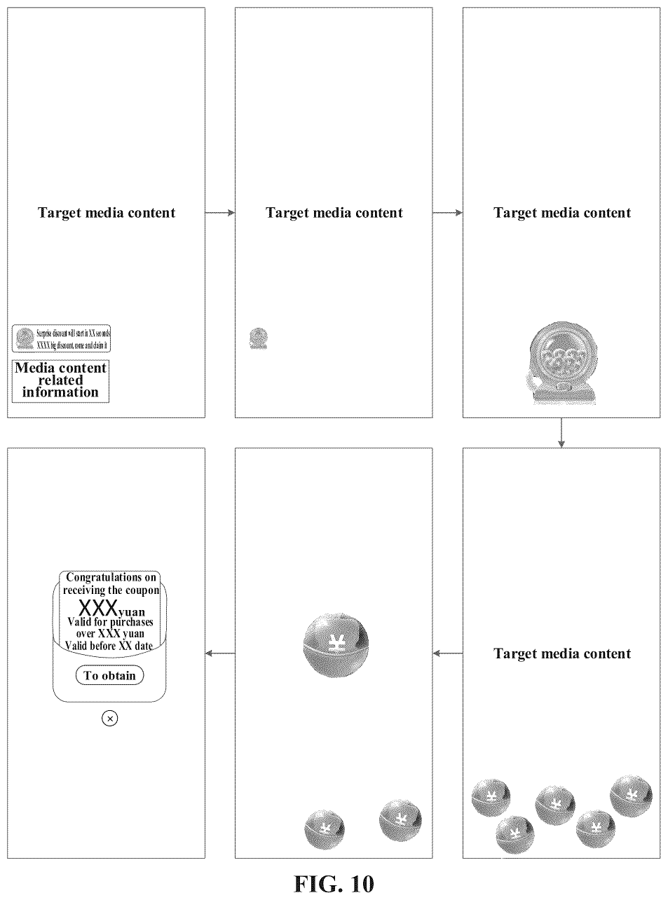

FIG. 10 is a schematic diagram of another display process of resource object information according to an embodiment of the present disclosure. As shown in FIG. 10, in another optional implementation, the display process of the resource object information may be described as follows.

When the target media content is displayed in the media content display page, the first interaction control may be displayed in the media content display page, and information such as the image of the preset object container, the prompt information for prompting the user to obtain the resource object, and/or the countdown for displaying the preset object container may be displayed in the first interaction control, as shown in the first image of FIG. 10.

When the current condition satisfies the third display condition, for example, when a trigger operation for the first interaction control is received, and/or when the countdown ends (that is, the display duration of the first interaction control reaches the fifth preset duration), the first interaction control may be canceled from being displayed, and the preset object container may be displayed at the associated position of the first interaction control, as shown in the second image of FIG. 10.

After the preset object container is displayed at the associated position of the first interaction control, the preset object container may be further controlled to move downward of the media content display page (that is, the third preset region), and a size of the preset object container may be increased during the moving process, as shown in the third image of FIG. 10. After the preset object container moves downward of the media content display page, the preset object container may be controlled to stop moving, and the preset object container may be controlled to shake circularly and display shake prompt information (not shown in FIG. 10), and the user is prompted by the shake prompt information that interaction may be performed by executing the shake trigger operation.

When the current condition satisfies the first display condition, for example, when the first trigger operation from the user is received, and/or when the second trigger operation for the preset object container is received, the size of the preset object container is controlled to be gradually increased to full screen and fade away; after the preset object container fades away, at least some of the interaction objects in the preset object container may continue to be displayed at the bottom of the media content display page (that is, the first preset region), as shown in the fourth image of FIG. 10. For example, taking the first trigger operation as an example including the shake trigger operation, when it is detected that the user executes the shake trigger operation, the preset object container may be controlled to be enlarged and fade away, and at least two interaction objects may be controlled to be enlarged and enter the preset object container, and the interaction objects may be supported to rotate 360 degrees in the preset object container and a picture display region of the media content display page with the shake trigger operation of the user. The resource object may be placed in the interaction object, and the user may see a style of the resource object placed inside the interaction object through a transparent part of the interaction object. In addition, if the user still does not execute the first trigger operation or the second trigger operation for the preset object container when the display duration of the preset object container reaches a set duration (for example, 3 s or 5 s), the preset object container may be canceled from being displayed, and the first interaction control may be redisplayed in the media content display page, so that the user may trigger the first interaction control to instruct the current application to redisplay the preset object container. It may be understood that for the case where the first interaction control is redisplayed, when the display duration of the first interaction control reaches the fifth preset duration, the preset object container may not be redisplayed, so as to avoid interference with the user watching the target media content.

When the current condition satisfies the second display condition, for example, when the duration since receipt of the first trigger operation reaches the second preset duration, when the third trigger operation for a displayed interaction object (that is, the target interaction object) is received, and/or when the display duration of the at least some of the interaction objects in the first preset region reaches the third preset duration, an interaction object may be randomly selected as the target interaction object or an interaction object triggered by the user is used as the target interaction object, and the target interaction object is controlled to move upward (that is, in the first direction), and the interaction objects other than the target interaction object are controlled to move downward (that is, in the second direction) and out of the media content display page, as shown in the fifth image of FIG. 10.

When the target interaction object moves upward to the preset position of the media content display page, the target interaction object may be controlled to stop moving, and the target interaction object is controlled to open to the resource object information corresponding to the target interaction object, as shown in the sixth image of FIG. 10.

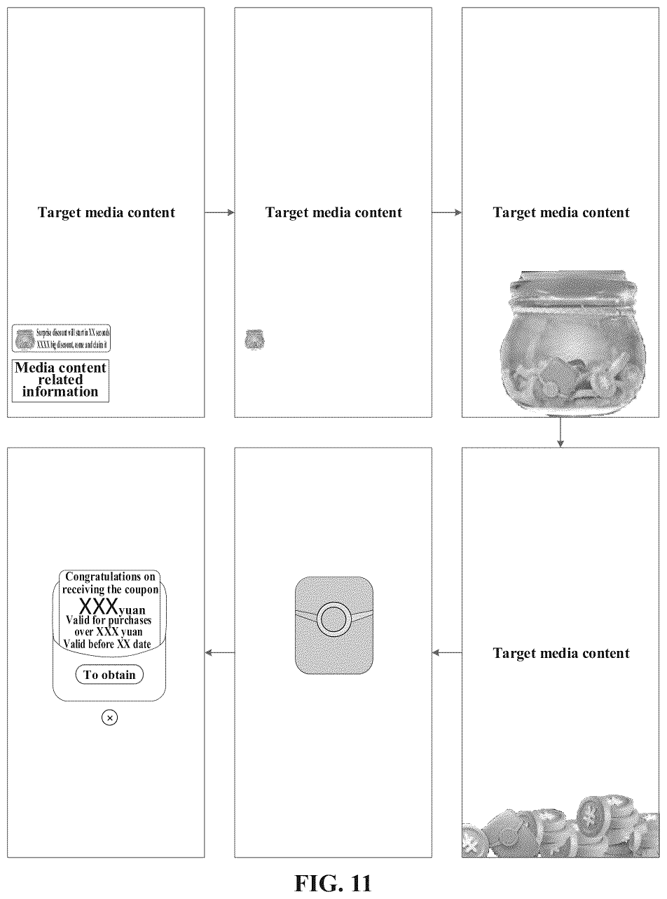

FIG. 11 is a schematic diagram of a further display process of resource object information according to an embodiment of the present disclosure. As shown in FIG. 11, in a further alternative implementation, the display process of the resource object information may be described as follows.

When the target media content is displayed in the media content display page, the first interaction control may be displayed in the media content display page, and information such as the image of the preset object container, the prompt information for prompting the user to obtain the resource object, and/or the countdown for displaying the preset object container may be displayed in the first interaction control, as shown in the first image of FIG. 11.

When the current condition satisfies the third display condition, for example, when a trigger operation for the first interaction control is received, and/or when the countdown ends (that is, the display duration of the first interaction control reaches the fifth preset duration), the first interaction control may be canceled from being displayed, and the preset object container may be displayed at the associated position of the first interaction control, as shown in the second image of FIG. 11.

After the preset object container is displayed at the associated position of the first interaction control, the preset object container may be further controlled to move downward of the media content display page (that is, the third preset region), and a size of the preset object container may be increased during the moving process, as shown in the third image of FIG. 11.

After the preset object container moves downward of the media content display page (that is, when the display duration of the preset object container reaches the fourth preset duration), the preset object container may be controlled to fade away, and the interaction objects contained in the preset object container may continue to be displayed in the second preset region of the media content display page, as shown in the fourth image of FIG. 11.

When the current condition satisfies the first display condition, for example, when the first trigger operation from the user is received, when the second trigger operation for the preset object container is received, and/or when the display duration of the preset object container (that is, the display duration of the at least two interaction objects contained in the preset object container) reaches the first preset duration, the interaction objects other than the target object may be canceled from being displayed, and the target interaction object may be controlled to move to the preset position of the media content display page, as shown in the fifth image of FIG. 11.

After the target interaction object moves to the preset position of the media content display page, the target interaction object may be controlled to open to the resource object information corresponding to the target interaction object, as shown in the sixth image of FIG. 11.

According to the method for object interaction provided in this embodiment of the present disclosure, when the first display condition is satisfied, the target interaction object is switched to display the resource object information corresponding to the target interaction object, and the interaction objects other than the target interaction object are canceled from being displayed, thereby further enriching the display manner of the resource object.

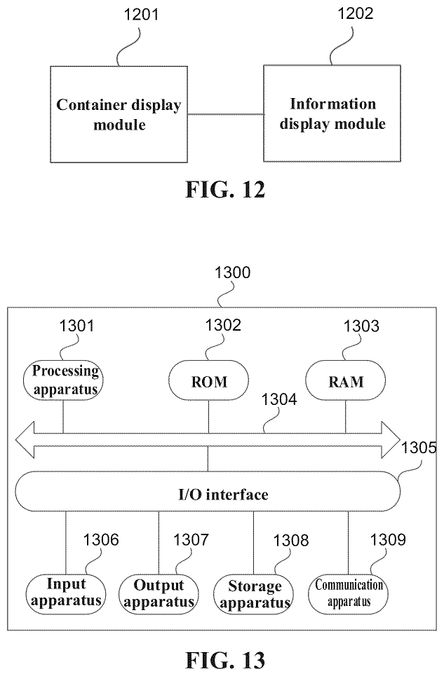

FIG. 12 is a block diagram of a structure of an apparatus for object interaction according to an embodiment of the present disclosure. The apparatus may be implemented by software and/or hardware, and may be configured in an electronic device. Typically, the apparatus may be configured in a mobile phone or a tablet computer, and may display an interaction object in an object container and display a resource object associated with media content when a set condition is satisfied by executing an object interaction method. As shown in FIG. 12, the apparatus for object interaction provided in this embodiment may include a container display module 1201, an information display module 1202, and an object obtaining module 1203, wherein
the container display module 1201 is configured to display a preset object container in a media content display page, and at least two interaction objects are contained in the preset object container, and the at least two interaction objects move upon receipt of a first trigger operation; and
the information display module 1202 is configured to display, in response to a first display condition being satisfied, resource object information corresponding to a target interaction object in the at least two interaction objects, and the resource object information is object information of a resource object, and the resource object is associated with target media content being displayed in the media content display page.

According to the apparatus for object interaction provided in this embodiment of the present disclosure, the container display module is configured to display the preset object container in the media content display page, the preset object container contains at least two interaction objects, and the at least two interaction objects move upon receipt of the first trigger operation; and the information display module is configured to display, in response to the first display condition being satisfied, the resource object information corresponding to the target interaction object of the at least two interaction objects, the resource object information is the object information of the resource object, and the resource object is associated with the target media content being displayed in the media content display page. With the above technical solution, the embodiments of the present disclosure may display the interaction objects in the manner of the object container, and enable the user to view the resource object information corresponding to the interaction objects when the first display condition is satisfied, thereby enriching the display manner of the interaction objects and the interaction manner based on the displayed interaction objects.

In the above solution, the first display condition may comprise at least one of the following: receipt of the first trigger operation, receipt of a second trigger operation for the preset object container, or a display duration of the at least two interaction objects reaching a first preset duration.

In the above solution, the information display module 1202 may be configured to switch the target interaction object to display the resource object information corresponding to the target interaction object, and cancel the display of interaction objects other than the target interaction object.

In the above solution, the information display module 1202 may be specifically configured to control the preset object container to open, and control the target interaction object to open to the resource object information corresponding to the target interaction object; and control the resource object information to be removed from the preset object container, and control the preset object container and the interaction objects other than the target interaction object to fade away during the removal of resource object information.

In the above solution, the information display module 1202 may be specifically configured to control the preset object container to fade away, and display at least some of the interaction objects in the preset object container in a first preset region of the media content display page; when a second display condition is satisfied, control the target interaction object to move along a first direction, and control the interaction objects other than the target interaction object to be removed from the media content display page in a second direction, wherein the second display condition comprises at least one of the following: a duration since receiving the first trigger operation reaching a second preset duration, receiving a third trigger operation for the target interaction object, and a display duration of the at least some of the interaction objects in the first preset region reaching a third preset duration; and when the target interaction object moves to a preset position of the media content display page, control the target interaction object to open to the resource object information corresponding to the target interaction object.

In the above solution, the information display module 1202 may be specifically configured to cancel displaying of the interaction objects other than the target interaction object, and control the target interaction object to move to a preset position of the media content display page; and when the target interaction object moves to the preset position, control the target interaction object to open to the resource object information corresponding to the target interaction object.

Further, the apparatus for object interaction provided in this embodiment may further include a first cancel display module configured to, after the preset object container is displayed in the media content display page, when a display duration of the preset object container reaches a fourth preset duration, cancel displaying of the preset object container, and display the at least two interaction objects in a second preset region of the media content display page, and the at least two interaction objects are displayed at a bottom of the second preset region.

In the above solution, the second preset region may be a picture display region of the media content display page, and the picture display region is configured to display a media content picture.

In the above solution, the container display module 1201 may be configured to display a first interaction control associated with the preset object container in the media content display page; and when a third display condition is satisfied, cancel displaying of the first interaction control, and display the preset object container at an associated position of the first interaction control, and the third display condition comprises at least one of the following: a fourth trigger operation for the first interaction control is received, and/or a display duration of the first interaction control reaches a fifth preset duration.

In the above solution, media content association information of the target media content may also be displayed in the media content display page, and the apparatus for object interaction provided in this embodiment may further include a second cancel display module configured to, when the third display condition is satisfied, cancel displaying of the media content association information.

In the above solution, the container display module 1201 may be further configured to, after the preset object container is displayed at the associated position of the first interaction control, control the preset object container to move to a third preset region of the media content display page.

In the above solution, the first display condition may comprise receiving the first trigger operation, and the apparatus for object interaction provided in this embodiment may further include a movement control module configured to, before the resource object information corresponding to the target interaction object of the at least two interaction objects is displayed, control, based on the first trigger operation, the at least two interaction objects to move in the preset object container or a second preset region of the media content display page.

Further, the apparatus for object interaction provided in this embodiment may further include at least one of the following: an object obtaining module configured to, in response to an obtain operation for the resource object, display an obtain page of the resource object; and a fourth cancel display module configured to, after the resource object information corresponding to the target interaction object of the at least two interaction objects is displayed, in response to a cancel display operation for the resource object information, cancel displaying of the resource object information, and display a second interaction control in the media content display page, and the second interaction control is configured to trigger redisplaying of the resource object information.

In the above solution, the at least two interaction objects may be at least two types of interaction objects, an object type of the target interaction object may be a target type in the at least two types; and/or the resource object may be configured to perform resource interaction, and the resource object information may comprise expiry information of the resource object.

In the above solution, the first trigger operation may comprise a shake trigger operation and/or a trigger operation for a preset button, and the preset button may be configured on the preset object container.

The apparatus for object interaction provided in this embodiment of the present disclosure may perform the object interaction method provided in any embodiment of the present disclosure, and has corresponding functional modules and beneficial effects for performing the object interaction method. For technical details not described in detail in this embodiment, reference may be made to the object interaction method provided in any embodiment of the present disclosure.

Reference is made to FIG. 13 below, which is a schematic diagram of a structure of an electronic device (for example, a terminal device) 1300 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 13 is merely an example, and shall not impose any limitation on the function and scope of use of the embodiments of the present disclosure.

As shown in FIG. 13, the electronic device 1300 may include a processing apparatus (for example, a central processor, a graphics processor, etc.) 1301 that may perform various appropriate actions and processing in accordance with a program stored in a read-only memory (ROM) 1302 or a program loaded from a storage apparatus 1308 into a random access memory (RAM) 1303. The RAM 1303 further stores various programs and data required for the operation of the electronic device 1300. The processing apparatus 1301, the ROM 1302, and the RAM 1303 are connected to each other through a bus 1304. An input/output (I/O) interface 1305 is also connected to the bus 1304.

Generally, the following apparatuses may be connected to the I/O interface 1305: an input apparatus 1306 including, for example, a touchscreen, a touchpad, a keyboard, a mouse, a camera, a microphone, an accelerometer, and a gyroscope; an output apparatus 1307 including, for example, a liquid crystal display (LCD), a speaker, and a vibrator; a storage apparatus 1308 including, for example, a tape and a hard disk; and a communication apparatus 1309. The communication apparatus 1309 may allow the electronic device 1300 to perform wireless or wired communication with other devices to exchange data. Although FIG. 13 shows the electronic device 1300 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 1309 and installed, installed from the storage apparatus 1308, or installed from the ROM 1302. When the computer program is executed by the processing apparatus 1301, the above-mentioned functions defined in the method of the embodiment of the present disclosure are performed.

It should be noted that the above-mentioned computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, where the computer-readable program code is carried. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program code contained in the computer-readable medium may be transmitted by any suitable medium, including but not limited to electric wires, optical cables, radio frequency (RF), etc., or any suitable combination thereof.

In some implementations, the client and the server may communicate using any currently known or future-developed network protocol such as a HyperText Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs which, when executed by the electronic device, cause the electronic device to display a preset object container in a media content display page, and at least two interaction objects are contained in the preset object container, and the at least two interaction objects move upon receipt of a first trigger operation; and display, in response to a first display condition being satisfied, resource object information corresponding to a target interaction object in the at least two interaction objects, and the resource object information is object information of a resource object, and the resource object is associated with target media content being displayed in the media content display page.

The computer program code for performing the operations of the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user through any kind of network, including a local area network (LAN) or a wide area network (WAN), or may be connected to an external computer (for example, connected through the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units described in the embodiments of the present disclosure may be implemented by software, or may be implemented by hardware. The name of a module does not in some cases constitute a limitation on the unit itself.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, Example 1 provides a method for object interaction, including:
displaying a preset object container in a media content display page, wherein at least two interaction objects are contained in the preset object container, and the at least two interaction objects move upon receipt of a first trigger operation; and
displaying, in response to a first display condition being satisfied, resource object information corresponding to a target interaction object in the at least two interaction objects, wherein the resource object information is object information of a resource object, and the resource object is associated with target media content being displayed in the media content display page.

According to one or more embodiments of the present disclosure, Example 2 is the method according to Example 1, and the first display condition comprises at least one of the following: receipt of the first trigger operation, receipt of a second trigger operation for the preset object container, or a display duration of the at least two interaction objects reaching a first preset duration.

According to one or more embodiments of the present disclosure, Example 3 is the method according to Example 1, and displaying resource object information corresponding to the target interaction object of the at least two interaction objects comprises:
switching the target interaction object to display the resource object information corresponding to the target interaction object, and canceling the display of interaction objects other than the target interaction object.

According to one or more embodiments of the present disclosure, Example 4 is the method according to Example 3, wherein switching the target interaction object to display the resource object information corresponding to the target interaction object, and canceling the display of interaction objects other than the target interaction object comprises:
controlling the preset object container to open, and controlling the target interaction object to open to the resource object information corresponding to the target interaction object; and
controlling the removal of resource object information from the preset object container, and controlling, during the removal of resource object information, the preset object container and the interaction objects other than the target interaction object to fade away.

According to one or more embodiments of the present disclosure, Example 5 is the method according to Example 3, wherein switching the target interaction object to display the resource object information corresponding to the target interaction object, and canceling the display of interaction objects other than the target interaction object comprises:
controlling the preset object container to fade away, and displaying at least some of the interaction objects in the preset object container in a first preset region of the media content display page;
when a second display condition is satisfied, controlling the target interaction object to move along a first direction, and controlling the interaction objects other than the target interaction object to move out of the media content display page in a second direction, wherein the second display condition comprises at least one of the following: a duration since receiving the first trigger operation reaching a second preset duration, receiving a third trigger operation for the target interaction object, and a display duration of the at least some of the interaction objects in the first preset region reaching a third preset duration; and
when the target interaction object moves to a preset position of the media content display page, controlling the target interaction object to open to the resource object information corresponding to the target interaction object.

According to one or more embodiments of the present disclosure, Example 6 is the method according to Example 3, wherein switching the target interaction object to display the resource object information corresponding to the target interaction object, and canceling the display of interaction objects other than the target interaction object comprises:
canceling displaying of the interaction objects other than the target interaction object, and controlling the target interaction object to move to a preset position of the media content display page; and
when the target interaction object moves to the preset position, controlling the target interaction object to open to the resource object information corresponding to the target interaction object.

According to one or more embodiments of the present disclosure, Example 7 is the method according to Example 1, and after the preset object container is displayed in the media content display page, the method further comprises:
when a display duration of the preset object container reaches a fourth preset duration, cancel displaying of the preset object container, and display the at least two interaction objects in a second preset region of the media content display page, wherein the at least two interaction objects are displayed at a bottom of the second preset region.

According to one or more embodiments of the present disclosure, Example 8 is the method according to Example 7, wherein the second preset region is a picture display region of the media content display page, and the picture display region is configured to display a media content picture.

According to one or more embodiments of the present disclosure, Example 9 is the method according to any of Examples 1 to 8, wherein the displaying a preset object container in a media content display page comprises:
displaying a first interaction control associated with the preset object container in the media content display page; and
when a third display condition is satisfied, cancel displaying of the first interaction control, and display the preset object container at an associated position of the first interaction control, wherein the third display condition comprises at least one of the following: a fourth trigger operation for the first interaction control is received, and/or a display duration of the first interaction control reaches a fifth preset duration.

According to one or more embodiments of the present disclosure, Example 10 is the method according to Example 9, wherein media content association information of the target media content is also displayed in the media content display page, and the method further comprises:
when the third display condition is satisfied, cancel displaying of the media content association information.

According to one or more embodiments of the present disclosure, Example 11 is the method according to Example 9, and after the preset object container is displayed at the associated position of the first interaction control, the method further comprises:
controlling the preset object container to move to a third preset region of the media content display page.

According to one or more embodiments of the present disclosure, Example 12 is the method according to any of Examples 1 to 8, wherein the first display condition comprises receiving the first trigger operation, and before the resource object information corresponding to the target interaction object of the at least two interaction objects is displayed, the method further comprises:
controlling, based on the first trigger operation, the at least two interaction objects to move in the preset object container or a second preset region of the media content display page.

According to one or more embodiments of the present disclosure, Example 13 is the method according to any one of Examples 1 to 8, and after the resource object information corresponding to the target interaction object of the at least two interaction objects is displayed, the method further comprises at least one of the following:
in response to an obtain operation for the resource object, displaying an obtain page of the resource object; and
in response to a cancel display operation for the resource object information, cancel displaying of the resource object information, and display a second interaction control in the media content display page, wherein the second interaction control is configured to trigger redisplaying of the resource object information.

According to one or more embodiments of the present disclosure, Example 14 is the method according to any of Examples 1 to 8, wherein the at least two interaction objects are at least two types of interaction objects, an object type of the target interaction object is a target type in the at least two types; and/or the resource object is configured to perform resource interaction, and the resource object information comprises expiry information of the resource object.

According to one or more embodiments of the present disclosure, Example 15 is the method according to any of Examples 1 to 8, wherein the first trigger operation comprises a shake trigger operation and/or a trigger operation for a preset button, and the preset button is configured on the preset object container.

According to one or more embodiments of the present disclosure, Example 16 provides an apparatus for object interaction, including:
a container display module configured to display a preset object container in a media content display page, wherein at least two interaction objects are contained in the preset object container, and the at least two interaction objects move upon receipt of a first trigger operation; and
an information display module configured to display, in response to a first display condition being satisfied, resource object information corresponding to a target interaction object of the at least two interaction objects, wherein the resource object information is object information of a resource object, and the resource object is associated with target media content being displayed in the media content display page.

According to one or more embodiments of the present disclosure, Example 17 provides an electronic device, including:
one or more processors; and
a memory configured to store one or more programs,
wherein the one or more programs, when executed by the one or more processors, cause the one or more processors to perform the method for object interaction according to any of Examples 1 to 15.

According to one or more embodiments of the present disclosure, Example 18 provides a computer-readable storage medium having a computer program stored thereon, where the program, when executed by a processor, causes the processor to perform the method for object interaction according to any one Examples 1 to 15.

The above description is merely preferred embodiments of the present disclosure and an illustration of the applied technical principles. A person skilled in the art should understand that the scope of disclosure involved in the present disclosure is not limited to the technical solution formed by a specific combination of the above technical features, and shall also cover other technical solutions formed by any combination of the above technical features or equivalent features thereof without departing from the above concept of disclosure. For example, a technical solution formed by replacing the above features with technical features with similar functions disclosed in the present disclosure (but not limited thereto).

In addition, although the various operations are depicted in a specific order, it should be understood as requiring these operations to be performed in the specific order shown or in a sequential order. Under specific circumstances, multitasking and parallel processing may be advantageous. Similarly, although several specific implementation details are contained in the above discussions, these details should not be construed as limiting the scope of the present disclosure. Some features that are described in the context of separate embodiments can also be implemented in combination in a single embodiment. In contrast, various features described in the context of a single embodiment can also be implemented in a plurality of embodiments individually or in any suitable sub combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms of implementing the claims.

I/We claim:

1. A method for object interaction, comprising:
displaying a preset object container in a media content display page, wherein at least two interaction objects are contained in the preset object container, and the at least two interaction objects move in response to receipt of a first trigger operation; and
displaying, in response to a first display condition being satisfied, resource object information corresponding to a target interaction object of the at least two interaction objects, wherein the resource object information is object information of a resource object, and the resource object is associated with target media content being displayed in the media content display page.

2. The method of claim 1, wherein the first display condition comprises at least one of: receipt of the first trigger operation, receipt of a second trigger operation for the preset object container, or a display duration of the at least two interaction objects reaching a first preset duration.

3. The method of claim 1, wherein displaying resource object information corresponding to the target interaction object of the at least two interaction objects comprise:
switching the target interaction object to display the resource object information corresponding to the target interaction object, and canceling the display of interaction objects other than the target interaction object.

4. The method of claim 3, wherein switching the target interaction object to display the resource object information corresponding to the target interaction object, and canceling the display of interaction objects other than the target interaction object comprises:
controlling the preset object container to open, and controlling the target interaction object to open as resource object information corresponding to the target interaction object; and
controlling the removal of resource object information from the preset object container, and controlling, during the removal of resource object information, the preset object container and the interaction objects other than the target interaction object to fade away.

5. The method of claim 3, wherein switching the target interaction object to display the resource object information corresponding to the target interaction object, and canceling the display of interaction objects other than the target interaction object comprises:
controlling the preset object container to fade away, and displaying at least some of the interaction objects in the preset object container in a first preset region of the media content display page;
in response to a second display condition being satisfied, controlling the target interaction object to move along a first direction, and controlling the interaction objects other than the target interaction object to move out of the media content display page in a second direction, wherein the second display condition comprises at least one of the following: a duration since receiving the first trigger operation reaching a second preset duration, receiving a third trigger operation for the target interaction object, and a display duration of the at least some of the interaction objects in the first preset region reaching a third preset duration; and
in response to the target interaction object moving to a preset position of the media content display page, controlling the target interaction object to open as the resource object information corresponding to the target interaction object.

6. The method of claim 3, wherein switching the target interaction object to display the resource object information corresponding to the target interaction object, and canceling the display of interaction objects other than the target interaction object comprises:
canceling displaying of the interaction objects other than the target interaction object, and controlling the target interaction object to move to a preset position of the media content display page; and
in response to the target interaction object moving to the preset position, controlling the target interaction object to open as the resource object information corresponding to the target interaction object.

7. The method of claim 1, wherein the method further comprises, after displaying the preset object container in the media content display page:
in response to a display duration of the preset object container reaching a fourth preset duration, canceling displaying of the preset object container, and displaying the at least two interaction objects in a second preset region of the media content display page, wherein the at least two interaction objects are displayed at a bottom of the second preset region.

8. The method of claim 7, wherein the second preset region is a picture display region of the media content display page, and the picture display region is configured to display a media content picture.

9. The method of claim 1, wherein displaying the preset object container in the media content display page comprises:
displaying a first interaction control associated with the preset object container in the media content display page; and
in response to a third display condition being satisfied, canceling the display of the first interaction control, and displaying the preset object container at an associated position of the first interaction control, wherein the third display condition comprises: receiving a fourth trigger operation for the first interaction control, and/or a display duration of the first interaction control reaching a fifth preset duration.

10. The method of claim 9, wherein media content association information of the target media content is further displayed in the media content display page, and the method further comprises:
in response to the third display condition being satisfied, canceling the display of the media content association information.

11. The method of claim 9, wherein the method further comprises, after displaying the preset object container at the associated position of the first interaction control:
controlling the preset object container to move to a third preset region of the media content display page.

12. The method of claim 1, wherein the first display condition comprises receiving the first trigger operation, and the method further comprises, before displaying resource object information corresponding to the target interaction object in the at least two interaction objects:
controlling, based on the first trigger operation, the at least two interaction objects to move in the preset object container or a second preset region of the media content display page.

13. The method of claim 1, wherein the method further comprises, after displaying resource object information corresponding to the target interaction object in the at least two interaction objects, at least one of the following:
in response to an obtain operation for the resource object, displaying an obtain page of the resource object; and
in response to a cancel display operation for the resource object information, canceling the display of the resource object information, and displaying a second interaction control in the media content display page, wherein the second interaction control is configured to trigger redisplaying of the resource object information.

14. The method of claim 1, wherein the at least two interaction objects are at least two types of interaction objects, an object type of the target interaction object is a target type in the at least two types, and/or the resource object is configured to perform resource interaction, and the resource object information comprises expiry information of the resource object.

15. The method of claim 1, wherein the first trigger operation comprises a shake trigger operation and/or a trigger operation for a preset button, and the preset button is configured on the preset object container.

16. An electronic device, comprising:
at least one processor; and
a memory communicatively connected to the at least one processor, wherein
the memory has a computer program stored thereon and executable by the at least one processor, and the computer program, when executed by the at least one processor, causes the at least one processor to:
display a preset object container in a media content display page, wherein at least two interaction objects are contained in the preset object container, and the at least two interaction objects move in response to receipt of a first trigger operation; and
display, in response to a first display condition being satisfied, resource object information corresponding to a target interaction object of the at least two interaction objects, wherein the resource object information is object information of a resource object, and the resource object is associated with target media content being displayed in the media content display page.

17. The device of claim 16, wherein the first display condition comprises at least one of: receipt of the first trigger operation, receipt of a second trigger operation for the preset object container, or a display duration of the at least two interaction objects reaching a first preset duration.

18. The device of claim 16, wherein the computer program causing the at least one processor to display resource object information corresponding to the target interaction object of the at least two interaction objects comprise instructions to:
switch the target interaction object to display the resource object information corresponding to the target interaction object, and canceling the display of interaction objects other than the target interaction object.

19. The device of claim 18, wherein the computer program causing the at least one processor to switch the target interaction object to display the resource object information corresponding to the target interaction object, and cancel the display of interaction objects other than the target interaction object comprises instructions to:
control the preset object container to open, and controlling the target interaction object to open as resource object information corresponding to the target interaction object; and
control the removal of resource object information from the preset object container, and control, during the removal of resource object information, the preset object container and the interaction objects other than the target interaction object to fade away.

20. A non-transitory computer-readable storage medium having computer instructions stored thereon, wherein the computer instruction, when executed by a processor, cause the processor to:
display a preset object container in a media content display page, wherein at least two interaction objects are contained in the preset object container, and the at least two interaction objects move in response to receipt of a first trigger operation; and
display, in response to a first display condition being satisfied, resource object information corresponding to a target interaction object of the at least two interaction objects, wherein the resource object information is object information of a resource object, and the resource object is associated with target media content being displayed in the media content display page.
